(19) United States
(12) Patent Application Publication
(10) Pub. No.: US 2013/0179144 A1
(43) Pub. Date: Jul. 11, 2013

(54) PERFORMANCE BOTTLENECK DETECTION IN SCALABILITY TESTING

(71) Applicants: Frank Lu, San Jose, CA (US); James Qiu, (US); John Li, (US)

(72) Inventors: Frank Lu, San Jose, CA (US); James Qiu, (US); John Li, (US)

(21) Appl. No.: 13/345,613

(22) Filed: Jan. 6, 2012

(51) Int. Cl. G06F 9/44

(52) U.S. Cl. 703/20

(57) ABSTRACT

A testing system can perform scalability testing on a target system, including automatically identifying a performance bottleneck component of the target system when the target system includes multiple components. The testing system can specify a target load of a specified component of the target system. The testing system can provide a simulated request to the target system and measure performance of the target system. Based on the measurement, the testing system can determine a scaling factor. The testing system can scale up the simulated request by the scaling factor, and determine whether one or more components of the target system have reached full capacity. The testing system can then adjust the scaling factor and the simulated request, until the testing system identifies a component of the target system that is a performance bottleneck of the target system when a specific number of requests are provided.

### TECHNICAL FIELD

This disclosure relates generally to system performance testing.

### BACKGROUND

Scalability of a system can refer to an ability of the system to process growing amount of work, or an ability of the system to be extended to accommodate the growing amount of work. Scalability testing often includes non-functional testing that measures the ability of the system to scale up or scale out. During scalability testing, the speed or reliability of a system can be tested against various amounts of load, various numbers of clients, various numbers of transactions, or various data volume. Scalability of the system can be measured using various indicators, including, for example, response time, processor utilization, memory consumption, or number of concurrent sessions supported. Oftentimes, the scalability of a system is limited by a performance bottleneck, which can be a single component the capacity of which limits the capacity of an entire system.

### SUMMARY

Methods, program products, and systems for automatic performance bottleneck detection are described. A testing system can perform scalability testing on a target system, including automatically identifying a performance bottleneck component of the target system when the target system includes multiple components. The testing system can specify a target load of a specified component of the target system. The testing system can provide a simulated request to the target system and measure performance of the target system. Based on the measurement, the testing system can determine a scaling factor. The testing system can scale up the simulated request by the scaling factor, and determine whether one or more components of the target system have reached full capacity. The testing system can then adjust the scaling factor and the simulated request, until the testing system identifies a component of the target system that is a performance bottleneck of the target system when a precise number of requests are provided.

Automatic performance bottleneck detection techniques can be implemented to achieve the following advantages. Automatic performance bottleneck detection can reduce time for finding a performance bottleneck of a target system during scalability testing. In a conventional testing framework, when scalability testing uncovers a potential performance bottleneck, engineers are engaged to perform analysis and troubleshooting to identify, remove, or improve a performance bottleneck. A testing system implementing automatic performance bottleneck detection techniques can automate the identification of a performance bottleneck.

A testing system implementing automatic performance bottleneck detection techniques can produce reports with variable granularity. Information on status of the target system right before or after the performance bottleneck occurs can be valuable. A testing system implementing automatic performance bottleneck detection techniques can provide detailed reports on system status right before or after a performance bottleneck occurs, and summary reports on system status at other time. The testing system can produce the reports with minimum user input. In addition, the testing system can reduce or eliminate redundant traces and log files that need to be analyzed by a user.

The details of one or more implementations of automatic performance bottleneck detection are set forth in the accompanying drawings and the description below. Other features, aspects, and advantages of automatic performance bottleneck detection will become apparent from the description, the drawings, and the claims.

### BRIEF DESCRIPTION OF THE DRAWINGS

FIG. 1 is a block diagram illustrating components of an exemplary performance bottleneck detection framework.

FIG. 2 is a line chart illustrating an exemplary critical point in automatic identification of a performance bottleneck.

FIG. 3 is a flowchart illustrating operations of an exemplary testing system.

FIG. 4 is a chart illustrating exemplary measurements of multiple performance indicators of a target system against different thresholds.

FIG. 5 is a flowchart illustrating an exemplary process of automatically identifying a performance bottleneck.

FIG. 6 is a flowchart illustrating an exemplary process of iteratively determining system status when a performance bottleneck has been identified.

FIG. 7 is a block diagram of an exemplary system architecture for implementing the features and operations of FIGS. 1-6.

Like reference symbols in the various drawings indicate like elements.

### DETAILED DESCRIPTION

### Overview

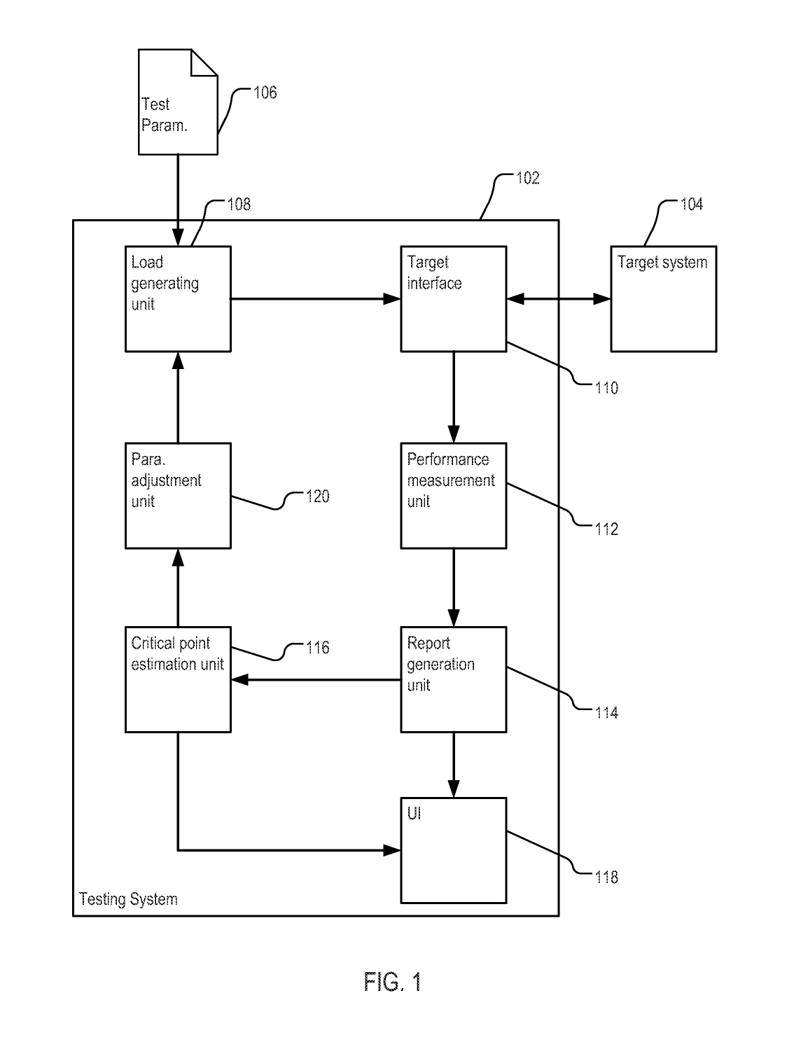

FIG. 1 is a block diagram illustrating components of an exemplary performance bottleneck detection framework. The framework can include testing system 102 and target system 104. From a high level, target system 104 can be a system under test (SUT) whose performance, including, e.g., functionality, scalability, or efficiency, is tested by testing system 102. Testing system 102 can be configured to measure a performance indicator, e.g., a key performance indicator (KPI) of target system 104. Exemplary KPIs can include response time (e.g., in millisecond or second), processor utilization rate (e.g., in percentage of total available processor power), memory consumption (e.g., in kilobytes, megabytes, or gigabytes), or number of concurrent sessions supported by target system 104.

Testing system 102 can apply a performance test by sending an initial request towards target system 104. The request can include a simulated interactive session between a simulated client and target system 104. The initial request can set a baseline for further scalability testing. The initial request can include a single session. In subsequent tests, testing system 102 can send multiple simulated requests to target system 104, e.g., by opening and maintaining multiple concurrent sessions with target system 104.

When the number of concurrent sessions in a test increases, load on various components of target system 104 can increase. Accordingly, when the number of concurrent sessions in the test increases, target system 104 can have increased resource utilization (e.g., more processor utilization or more memory consumption). Testing system 102 can be configured to identify a performance bottleneck of target system 104 by inspecting patterns of increase in the resource utilization of target system 104 in multiple iterations of testing. Additional details of automatic performance bottleneck detection are set forth below.

In the example of FIG. 1, testing system 102 can receive testing parameters 106. Testing parameter 106 can include a specified KPI and a target load for the specified KPI. The KPI can be in the form of response time (in millisecond, second, etc.), processor utilization (percent of the total available CPU power), memory consumption (in KB, MB or GB), or the number of concurrent sessions supported by target system 104. Testing system 102 can configure a scalability test of target system 104, including determining a number of concurrent sessions to provide to target system 104, based on testing parameters 106.

Testing system 102 can include load generating unit 108. Load generating unit 108 can be a component of testing system 102 configured to generate one or more simulated requests for testing target system 104. Load generating unit 108 can generate multiple simulated requests to be provided to target system 104 concurrently. The number of concurrent requests can be reconfigured for each iteration of the scalability test based on a data profile of a previous iteration, until the test reaches maximum scalability. The test can reach maximum scalability when the KPI specified in testing parameter 106 satisfies the target load, or when a performance bottleneck is identified and system condition at the performance bottleneck is determined. The data profile at the first iteration (where no “previous” iteration is available) can be initialized using information in testing parameters 106. The number of simulated requests can be adjusted, e.g., increased or decreased, in each iteration, based on the data profile of a previous iteration.

Upon receiving testing parameter 106, testing system 102 can generate an initial test. Load generating unit 108 of testing system 102 can generate an initial number of one or more simulated requests. The initial number of simulated requests can correspond to a low client count (e.g., one simulated client only). Testing system 102 can provide the one or more simulated requests to target system 104 through target interface 110. Target interface 110 can be a component of testing system 102 that is configured to send simulated requests to, and receive responses from, target system 104 and other target systems. In addition, target interface 110 can provide interfaces to various components (e.g., processor or memory) of target system 104 such that performance indicators of target system 104 can be measured.

Testing system 102 can include performance measurement unit 112. Performance measurement unit 112 can be a component of testing system 102 configured to measure one or more performance indicators of target system 104. Performance measurement unit 112 can measure performance and, more specifically, performance trend, of each component of target system 104. For example, performance measurement unit 112 can measure a response time (based on responses received through target interface 110). Performance measurement unit 112 can determine whether target system 104 has reached performance capacity. Performance measurement unit 112 can determine that target system 104 has reached performance capacity when (1) performance measurement unit 112 detects a drastic change in a pattern of a performance indicator when a number of simulated requests increases; (2) a pre-defined performance threshold is reached; (3) when target system 104 crashes; or (4) when target system 104 becomes irresponsive, e.g., hangs.

Performance measurement unit 112 can provide the measured performance indicator values to report generation unit 114. Report generation unit 114 can be a component of testing system 102 configured to automatically generate a data profile based on the performance indicator values from performance measurement unit 112. Report generation unit 114 can organize the performance indicator values into the data profile for each iteration.

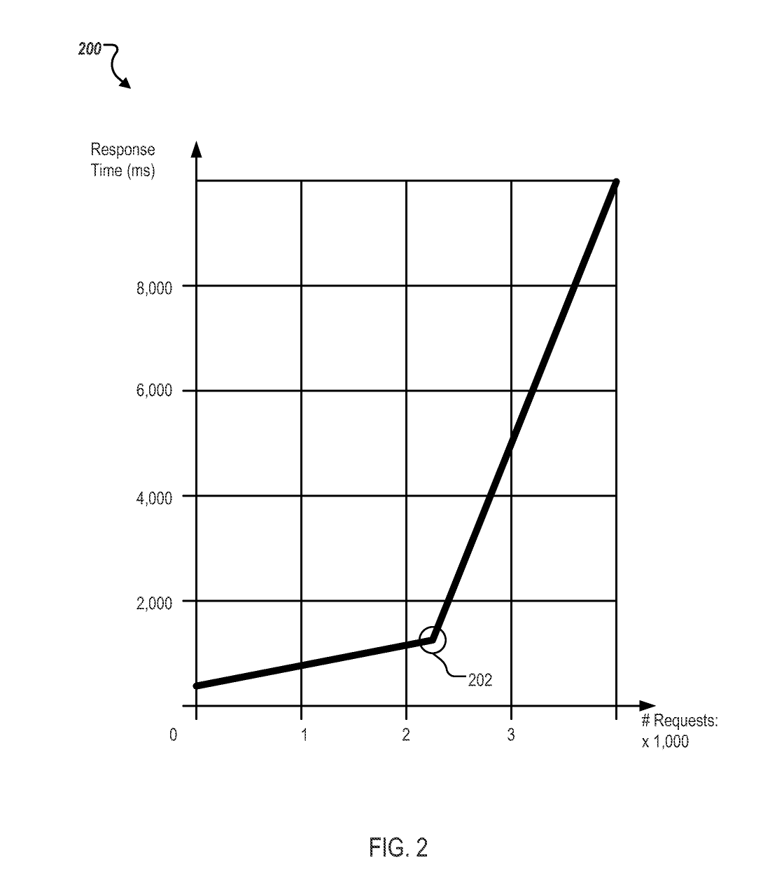

Report generation unit 114 can provide each data profile to critical point estimation unit 116. Critical point estimation unit 116 can be a component of testing system 102 configured to determine a critical point of target system 104. A critical point can be a number of simulated requests that correspond to a performance bottleneck. Further details of critical points will be described below in reference to FIG. 2. Critical point estimation unit 116 can record a number of simulated clients when performance measurement unit 112 determines that target system 104 has reached performance capacity. Critical point estimation unit 116 can identify a performance bottleneck of target system 104 based on the critical point. If critical point estimation unit 116 identifies a performance bottleneck, critical point estimation unit 116 can submit the identified performance bottleneck to user interface 118. Testing system 102 can provide information on the identified performance bottleneck, as well as performance indicators associated with the identified performance bottleneck, for display on a display device through user interface 118.

If a performance bottleneck is not identified, or when testing system 102 requests more granular information on load of target system 104, critical point estimation unit 116 can send each data profile to parameter adjustment unit 120. Parameter adjustment unit 120 can be a component of testing system 102 configured to determine a scaling factor based on the data profile. The scaling factor can be a value based on which load generation unit 108 can increase or decrease the number of simulated requests for providing to target system 104. Parameter adjustment unit 120 can provide the scaling factor to load generation unit 108 for a next iteration of scalability testing. Iterations of the scalability testing can terminate, when a performance bottleneck of target 104 is identified and detailed information on condition of the performance bottleneck, including a number of concurrent requests that triggered the performance bottleneck, is determined.

### Exemplary Critical Point

FIG. 2 is line chart 200 illustrating an exemplary critical point in automatic identification of a performance bottleneck. A first axis of line chart 200 can represent a number of concurrent requests. The concurrent requests can be generated by load generating unit 108 of FIG. 1. Each of the requests can simulate a distinct client requesting service from a target system. Each of the requests can be generated by a distinct thread.

A second axis of line chart 200 can represent a performance indicator of the target system. For illustrative purposes, the performance indicator includes a response time. In various implementations, other performance indicators can be used. The response time can be an amount of time between the target system's receiving a request and the target system's providing a response to the request in an interactive session between a simulated client and the target system.

A testing system testing the target system can identify a scaling pattern, which can be a pattern of change (increase or decrease) of response time in reference to the increase of number of simulated requests, e.g., concurrent sessions. The scaling pattern can be estimated using a formula as follows.

$$P = \frac{d R}{d N} , \qquad ( 1 )$$

where P indicates a scaling pattern, dR is an amount of change in response time or resource utilization, and dN is an amount of change in number of threads. The values of dR and dN can be determined based on different iterations of a scalability test.

When the testing system increases the number of simulated requests, the testing system can monitor changes of the scaling pattern P. If the value of P remains constant or substantially constant, e.g., in the example of FIG. 2, when the number of requests is fewer than 2,250, the testing system can determine that the target system has not reached capacity. If the testing system determines that scaling pattern P changes drastically at a point, the testing system can determine that the target system has reached capacity. In the example shown, before point 202, the scaling pattern P can have a first value; after point 202, the pattern P can have a second value. When the difference between first value and second value satisfies formula (2) as shown below, the system can determine that the target system has reached capacity, and designate point 202 as a critical point:

|P_{N}_{₀}_{^{−}}−P_{N}_{₀}_{⁺}|>=T_{P}, (2)

where N₀ is a point (e.g., point 202) representing a number of simulated request, which will be designated as a critical point; P_{N}_{N}_{₀}_{^{−}} is a first scaling pattern before N₀ simulated requests are provided to the target system; P_{N}_{₀}_{⁺} is a second scaling pattern after N₀ simulated requests are provided to the target system, and T_{P} is a pre-specified critical point threshold.

In some implementations, the testing system can identify a critical point when, after reaching a number of simulated requests, the scaling pattern changes from a constant into a linear function of the number of requests, indicating that the response time grows exponentially. The testing system can identify a critical point using formula (3) as shown below.

P_{N}_{₀}_{^{−}} =c;

P_{N}_{₀}_{⁺}=aN+b, (3)

where N₀ is a point (e.g., point 202) representing a number of simulated requests, which will be designated as a critical point; P_{N}_{₀}_{^{−}} is a first scaling pattern before N₀ simulated requests are provided to the target system; P_{N}_{₀}_{⁺} is a second scaling pattern after N₀ simulated requests are provided to the target system, and a, b, and c are constants.

In some implementations, the testing system can identify a critical point when, after reaching a number of simulated requests, the scaling pattern plateaus for a performance indicator, indicating the target system cannot handle more concurrent requests.

When the testing system identifies critical point N₀, e.g., point 202, the testing system can determine that a performance bottleneck has been reached, and report the performance bottleneck and a parameter (e.g., number of simulated clients) that caused the target system to reach the performance bottleneck.

### Operations of an Exemplary Testing System

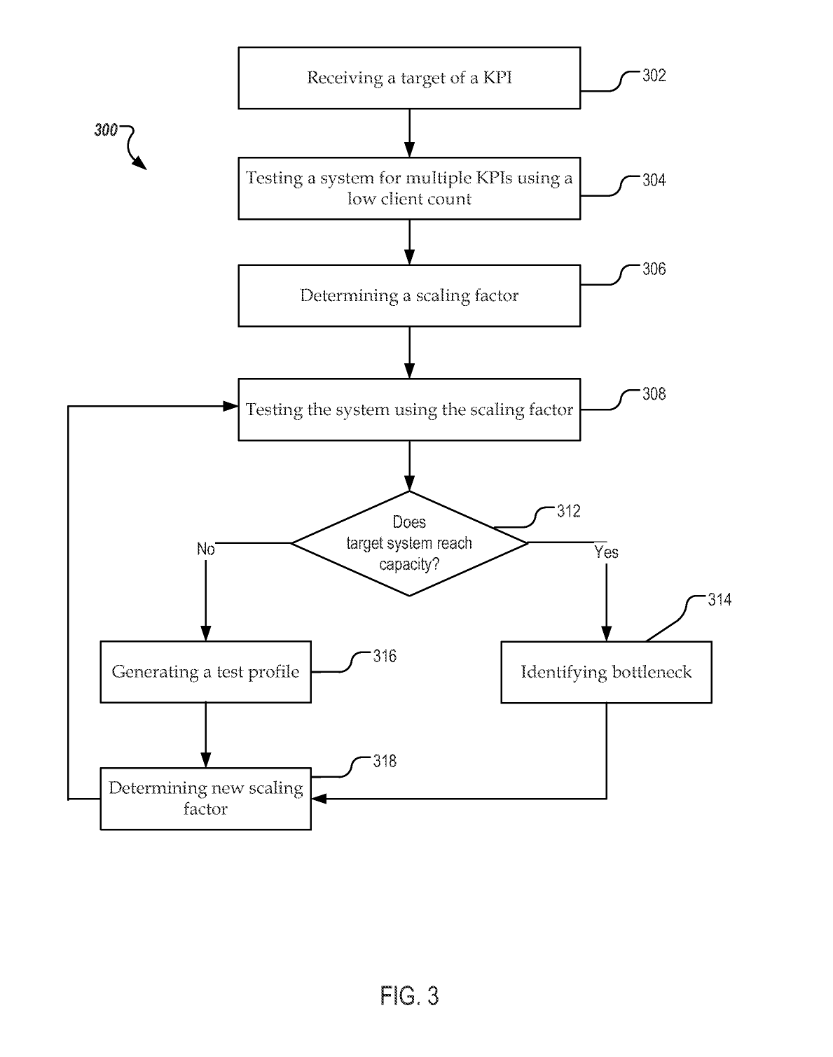

FIG. 3 is a flowchart illustrating operations 300 of an exemplary testing system. The testing system can receive (302) a target, e.g., 80%, of a performance indicator, e.g., processor load, for a specified component of a target system. The testing system can determine a test configuration and number of concurrent requests using the target.

The testing system can test (304) the target system on multiple performance indicators using a first number of concurrent requests. For example, the testing system can open a single session between a simulated client and the target system. The testing system can generate a data profile on multiple performance indicators of the target system handling the single session.

The testing system can determine (306) a scaling factor. Determining the scaling factor can include determining a value of a performance indicator on the specified component of the target system corresponding to the number of concurrent requests, and designating a ratio between the target performance indicator and the determined value as the scaling factor.

The testing system can test (308) the target system using the scaling factor. The testing system can multiply the first number of concurrent requests by the scaling factor to determine a second number of concurrent requests, and provide the second number of concurrent requests to the target system. Testing the target system using the scaling factor can include measuring multiple performance indicators on multiple components of the target system when the target system handles the second number of concurrent requests.

The system can determine (312) whether the target system has reached capacity. For example, the testing system can determine whether a critical point is reached for one or more performance indicators of the target system. The testing system can determine that the target system has reached capacity if a critical point is reached on a performance indicator.

If the target system has reached capacity, the testing system can identify (314) a performance bottleneck of the testing system. If the target system has not reached capacity, the testing system can generate (316) a data profile. In both cases, the testing system can determine (318) a new scaling factor and repeat the test, unless a performance bottleneck is identified and the testing system can provide a report that includes details that satisfy a pre-specified granularity.

Determining the new scaling factor can include adjusting a current scaling factor up, if the target system has not reached capacity, or adjusting a current scaling factor down, if a performance bottleneck has been reached. Adjusting the current scaling factor up can include multiplying the current scaling factor by a ratio between the target performance indicator, e.g., 80% processor load, and a current performance indicator of the performance indicator, e.g., 50% processor load. Adjusting the current scaling factor down can include multiplying the current scaling factor by a ratio between a smallest critical point and the second number of sessions.

The system can repeat the operations of testing (308) the target system until a critical point and a corresponding performance bottleneck is pinpointed. The system can then generate a report on the critical point and the performance bottleneck.

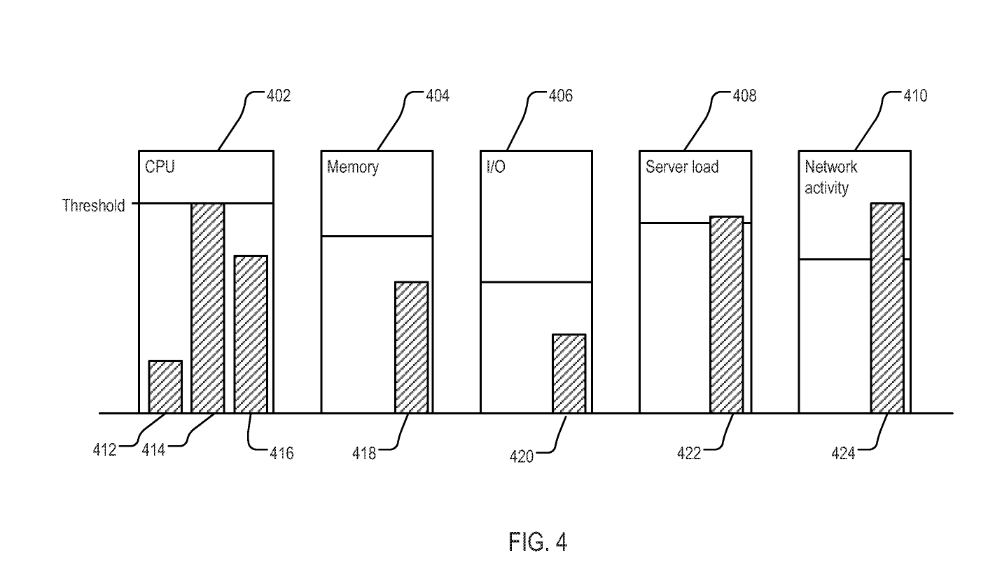

FIG. 4 is a chart illustrating exemplary measurements of multiple performance indicators of a target system against different thresholds. For illustrative purposes, the performance indicators can include processor utilization rate 402, memory usage 404, input/output activity 406, server load 408, and network activity 410. Each performance indicator can correspond to a threshold value that, if reached, indicates that the target system has reached capacity. The threshold value for each performance indicator can be known or unknown. The known threshold values can be specified by a user. For example, a user can specify that the target system has reached capacity if the processor (e.g., CPU) utilization rate reaches value X (e.g., 80%), if the memory usage reaches value Y (e.g., 10 GB), or if the network activity is using value Z (e.g., 60%) of the available network capacity. The unknown threshold values can include a still unknown utilization rate of a component of the target that, if reached, will cause the target system performance to deteriorate drastically when further requests are provided.

In the example shown, a target of a performance indicator (e.g., 80%) for CPU utilization rate is specified. A testing system can perform an initial test with a first number of concurrent simulated requests. The testing system can determine that, for example, first CPU utilization rate 412 at the target system is 20% when the target system is handling the first number of concurrent simulated requests. The system can determine a scaling factor by dividing the target performance indicator and first CPU utilization rate 412 (e.g., 80%/20%=4.0). The testing system can provide a second number of requests to the target system, where the second number of requests equals to the first number of requests times the scaling factor. The testing system can calculate the second number under the assumption that, if utilization rate grows linearly proportional to the number of concurrent requests, CPU utilization rate 414, as caused by the second number of requests, will reach the target of performance indicator for CPU utilization rate.

CPU utilization rate 416 of the target system, when the second number of requests are provided to the target system, may or may not fit the assumption. For example, CPU utilization rate 416 may be 60%, rather than 80% as projected. The testing system can increase the scaling factor to attempt to reach the target 80% CPU utilization rate if no other component is identified as a performance bottleneck, or decrease the scaling factor when a performance bottleneck is identified, such that the performance bottleneck and a condition that causes the performance bottleneck can be pinpointed.

In the example shown, the testing system can determine that, when handling the second number of concurrent requests, the target system has memory utilization rate 418 and I/O activity measure 420 that each did not reach a corresponding threshold. The testing system can determine that, when handling the second number of concurrent requests, the target system has server load 422 and network load 424 that each reached or exceeded a corresponding threshold. The system can identify a performance indicator, e.g., network activity 410, in which the target system exceeds the threshold the most in absolute value or proportionally. The testing system can adjust the scaling factor down proportionally, and re-test the target system in a next iteration. The adjustment may not lead to a linear reduction of network load 424 or server load 422. The testing system can continue the adjusting and testing operations until, for example, at a given number of concurrent requests, one or more performance indicators are at the threshold value. The testing system can identify the component or resource corresponding to the one or more performance indicators (e.g., network bandwidth) as a performance bottleneck. The testing system can then report the performance bottleneck and the number of concurrent connections that led to the performance bottleneck in a user interface.

### Exemplary Performance Bottleneck Detection Processes

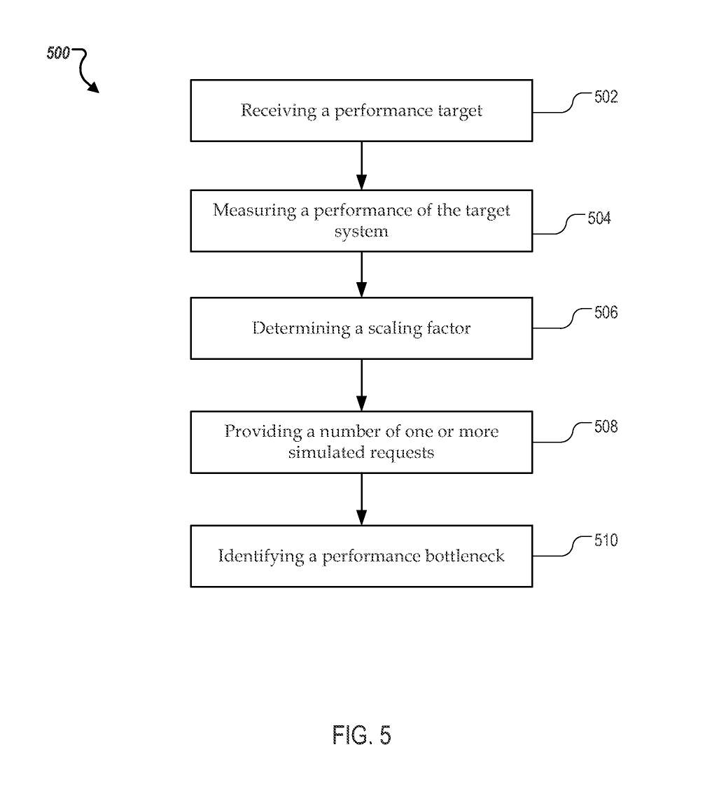

FIG. 5 is a flowchart illustrating exemplary process 500 of automatically identifying a performance bottleneck. A testing system can receive (502) a performance target specifying a target load level of a specified component or on a specified performance indicator of a target system. The target system can be configured to execute a computer software, e.g., an application program. The target system can include multiple hardware and software components, including, for example, a processor, a memory device, an I/O device, or a network device.

The testing system can measure (504) performance of the target system, including providing a simulated request to the system and determining a measured load at the specified component of the target system when the target system responds to the simulated request. The simulated request can include an interactive session between the testing system and the target system in which the testing system simulates actions of a client to the target system. Providing the simulated request can include providing the simulated request to the target system from a simulated client thread. Measuring the performance of the target system can include determining a measured load at the each of the components of the target system responding to the simulated request.

The testing system can determine (506) a scaling factor based at least in part on simulated request and the measured load. The testing system can determine the scaling factor without human intervention. The testing system can determining the scaling factor based on a ratio of a portion of a given system resource used by the target system and a total amount of the given system resource available at the target system. In addition, determining the scaling factor can be based on the measured load at each component and a capacity of a corresponding component.

The testing system can provide (508) a number of one or more simulated requests to the target system concurrently. The testing system can determine the number based on the scaling factor.

The system can identify (510) a performance bottleneck of the system executing the computer software when at least one of the components of the target system reaches a performance threshold in response to the number of one or more simulated requests. The performance threshold can include a user-specified load level at a component, a performance critical point, or both. The performance critical point can be a number of simulated requests where a pattern of resource usage before the performance critical point is different from a pattern of resource usage after the performance critical point.

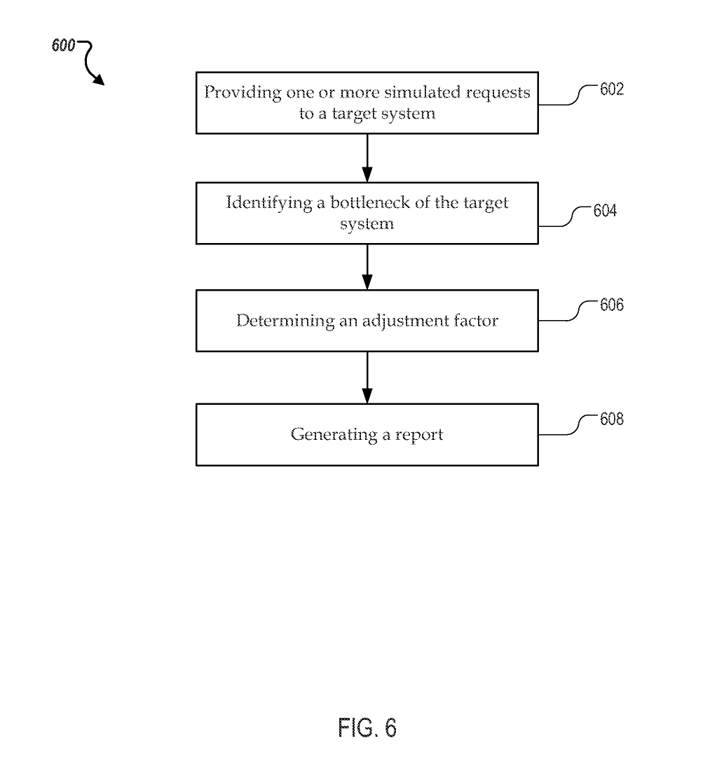

FIG. 6 is a flowchart illustrating exemplary process 600 of iteratively determining system status when a performance bottleneck has been identified. A testing system can provide (602) one or more simulated requests to a target system. The target system can include multiple components. The performance of each component can be measured by one or more performance indicators.

The testing system can identify (604) a performance bottleneck of the target system. The performance bottleneck can include a setting of a component of the target system that caused the data processing to exceed the specified load level. The setting of the component can include, for example, a number of processors or a performance measure of a processor, an amount of memory, or a configuration of an I/O device, a server, or a network. The specified load level can include a load indicator defined by a predetermined performance indicator, a performance change threshold, or a predetermined response time. The predetermined performance indicator can include, for example, a processor utilization rate value, a memory consumption value, an input/output (IO) load value, a server load, a number of concurrent sessions executing on the data processing device, a network load, or any combination of the above.

The performance change threshold can correspond to a critical point as described in reference to FIG. 2. An additional simulated request, if added to the target system, can cause a performance indicator of the target system to change by an amount that exceeds the performance change threshold. Additionally or alternatively, the additional simulated request can cause the performance indicator of the data processing device to change in a specified pattern, e.g., exponentially.

In some implementations, identifying the performance bottleneck can include determining that, at a setting of a component, the component is operating at a pre-specified capacity in response to the one or more simulated requests. In some implementations, identifying the bottleneck can include determining that the target system crashes or becomes irresponsive when processing the one or more simulated requests.

The testing system can determine (606) an adjustment factor such that, when a count of the simulated requests is adjusted by the adjustment factor, the target system does not exceed the specified load level. Determining the adjustment factor can include iteratively increasing or decreasing the count of the simulated requests and measuring performance of the target system on handling the increased or decreased count of simulated requests. Determining the adjustment factor can include modifying a value of the adjustment factor by an amount that is determined based at least in part on a previously generated report. The testing system can determine the adjustment factor without human intervention.

The testing system can generate (608) a report. The report can include one or more performance indicators upon reaching the specified load level. The report can include detailed information on how performance of the target system changes in response to a change in number of simulated requests concurrently provided to the target system when the target system is at or near the specified load level. The report can include summary information on how performance of the target system changes in response to a change in number of simulated requests concurrently provided to the target system when the target system is not at or near the specified load level.

### Exemplary System Architecture

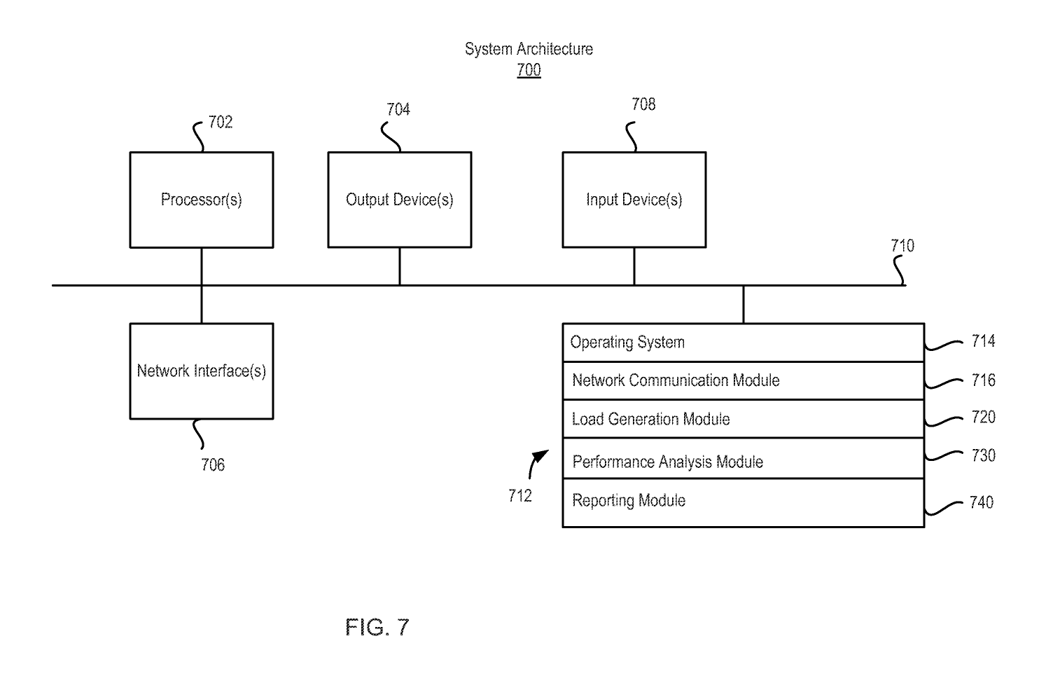

FIG. 7 is a block diagram of an exemplary system architecture 700 for implementing the features and operations of FIGS. 1-6. Other architectures are possible, including architectures with more or fewer components. In some implementations, architecture 700 includes one or more processors 702 (e.g., dual-core Intel® Xeon® Processors), one or more output devices 704 (e.g., LCD), one or more network interfaces 706, one or more input devices 708 (e.g., mouse, keyboard, touch-sensitive display) and one or more computer-readable mediums 712 (e.g., RAM, ROM, SDRAM, hard disk, optical disk, flash memory, etc.). These components can exchange communications and data over one or more communication channels 710 (e.g., buses), which can utilize various hardware and software for facilitating the transfer of data and control signals between components.

The term “computer-readable medium” refers to a medium that participates in providing instructions to processor 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 712 can further include operating system 714 (e.g., a Linux® operating system), network communication module 716, load generation module 720, performance analysis module 730, and reporting module 740. Operating system 714 can be multi-user, multiprocessing, multitasking, multithreading, real time, etc. Operating system 714 performs basic tasks, including but not limited to: recognizing input from and providing output to devices 706, 708; keeping track and managing files and directories on computer-readable mediums 712 (e.g., memory or a storage device); controlling peripheral devices; and managing traffic on the one or more communication channels 710. Network communications module 716 includes various components for establishing and maintaining network connections (e.g., software for implementing communication protocols, such as TCP/IP, HTTP, etc.).

Load generation module 720 can include computer instructions that, when executed, cause processor 702 to generate one or more simulated requests for providing to a target system. Performance analysis module 730 can include computer instructions that, when executed, cause processor 702 to measure a performance indicator of a target system, determining a critical point, and adjust a scaling factor. Reporting module 740 can include computer instructions that, when executed, cause processor 702 to generate for display a data view and a user interface item that indicates a performance bottleneck and status of a target system associated with the performance bottleneck.

Architecture 700 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A method comprising:
receiving a performance target specifying a target load level of a specified component of a target system executing a computer software, the target system including a plurality of components;
measuring performance of the target system, including providing a simulated request to the system and determining a measured load at the specified component of the target system when the target system responds to the simulated request;
determining a scaling factor based at least in part on simulated request and the measured load;
providing a number of one or more simulated requests to the target system concurrently, the number being determined based on the scaling factor; and
identifying a performance bottleneck of the system executing the computer software when at least one of the components of the system reaches a performance threshold in response to the number of one or more simulated requests.

2. The method of claim 1, wherein the plurality of components includes at least one of a processor, a memory device, an input/output (I/O) device, or a network device.

3. The method of claim 1, wherein providing the simulated request includes providing the simulated request to the target system from a client thread.

4. The method of claim 1, wherein each of the scaling factor and the number of one or more simulated requests is determined without human intervention.

5. The method of claim 1, wherein measuring the performance of the target system comprises determining a measured load at the each of the components of the target system responding to the simulated request.

6. The method of claim 5, wherein determining the scaling factor is additionally based on the measured load at each component and a capacity of a corresponding component.

7. The method of claim 1, wherein the performance threshold includes at least one of:
a user-specified load level; or
a performance critical point, wherein a pattern of resource usage before the performance critical point is different from a pattern of resource usage after the performance critical point.

8. A method comprising:
providing one or more simulated requests to a target system, the target system including a plurality of components;
identifying a performance bottleneck of the target system, the performance bottleneck including a setting of a component of the target system that caused the target system to exceed a specified load level; and
determining an adjustment factor such that, when a count of the simulated requests is adjusted by the adjustment factor, the target system does not exceed the specified load level, wherein determining the adjustment factor includes iteratively increasing or decreasing the count of the simulated requests and measuring performance of the target system when the target system handles the increased or decreased count of simulated requests.

9. The method of claim 8, wherein the specified load level includes a load indicator defined by at least one of:
a predetermined performance indicator; or
a performance change threshold, wherein an additional simulated request causes a performance indicator of the target system to change an amount that exceeds the performance change threshold, or wherein an additional simulated request causes the performance indicator of the target system to change in a specified pattern.

10. The method of claim 9, wherein the predetermined performance indicator includes at least one of:
a response time;
a processor utilization rate value;
a memory consumption value;
an input/output (I/O) load value;
a server load;
a number of concurrent sessions executing on the target system; or a network load.

11. The method of claim 8, wherein identifying the performance bottleneck comprises:
determining that, at the setting of the component, the component is operating at a pre-specified capacity.

12. The method of claim 8, comprising:
generating a report that includes one or more performance indicators upon reaching the specified load level.

13. The method of claim 12, wherein determining the adjustment factor includes modifying a value of the adjustment factor by an amount that is determined based at least in part on a previously generated report.

14. The method of claim 8, wherein the setting of the component includes at least one of:
a number of processors or a performance measure of a processor;
an amount of memory; or
a configuration of an input/output (I/O) device, a server, or a network.

15. The method of claim 8, wherein determining the adjustment factor is performed without human intervention.

16. A non-transitory storage device storing computer instructions operable to cause one or more processors to perform operations comprising:
receiving a performance target specifying a target load level of a specified component of a target system executing a computer software, the target system including a plurality of components;
measuring performance of the target system, including providing a simulated request to the system and determining a measured load at the specified component of the target system when the target system responds to the simulated request;
determining a scaling factor based at least in part on simulated request and the measured load;
providing a number of one or more simulated requests to the target system concurrently, the number being determined based on the scaling factor; and
identifying a performance bottleneck of the system executing the computer software when at least one of the components of the system reaches a performance threshold in response to the number of one or more simulated requests.

17. The device of claim 16, wherein the plurality of components includes at least one of a processor, a memory device, an input/output (I/O) device, or a network device.

18. The device of claim 16, wherein providing the simulated request includes providing the simulated request to the target system from a client thread.

19. The device of claim 16, wherein each of the scaling factor and the number of one or more simulated requests is determined without human intervention.

20. The device of claim 16, wherein measuring the performance of the target system comprises determining a measured load at the each of the components of the target system responding to the simulated request.

21. The device of claim 20, wherein determining the scaling factor is additionally based on the measured load at each component and a capacity of a corresponding component.

22. The device of claim 16, wherein the performance threshold includes at least one of:
a user-specified load level; or
a performance critical point, wherein a pattern of resource usage before the performance critical point is different from a pattern of resource usage after the performance critical point.

23. A non-transitory storage device storing computer instructions operable to cause one or more processors to perform operations comprising:
providing one or more simulated requests to a target system, the target system including a plurality of components;
identifying a performance bottleneck of the target system, the performance bottleneck including a setting of a component of the target system that caused the target system to exceed a specified load level; and
determining an adjustment factor such that, when a count of the simulated requests is adjusted by the adjustment factor, the target system does not exceed the specified load level, wherein determining the adjustment factor includes iteratively increasing or decreasing the count of the simulated requests and measuring performance of the target system when the target system handles the increased or decreased count of simulated requests.

24. The device of claim 23, wherein the specified load level includes a load indicator defined by at least one of:
a predetermined performance indicator; or
a performance change threshold, wherein an additional simulated request causes a performance indicator of the target system to change an amount that exceeds the performance change threshold, or wherein an additional simulated request causes the performance indicator of the target system to change in a specified pattern.

25. The device of claim 24, wherein the predetermined performance indicator includes at least one of:
a response time;
a processor utilization rate value;
a memory consumption value;
an input/output (I/O) load value;
a server load;
a number of concurrent sessions executing on the target system; or a network load.

26. The device of claim 23, wherein identifying the performance bottleneck comprises:
determining that, at the setting of the component, the component is operating at a pre-specified capacity.

27. A system comprising:
one or more processors configured to perform operations comprising:
receiving a performance target specifying a target load level of a specified component of a target system executing a computer software, the target system including a plurality of components;
measuring performance of the target system, including providing a simulated request to the system and determining a measured load at the specified component of the target system when the target system responds to the simulated request;
determining a scaling factor based at least in part on simulated request and the measured load;
providing a number of one or more simulated requests to the target system concurrently, the number being determined based on the scaling factor; and
identifying a performance bottleneck of the system executing the computer software when at least one of the components of the system reaches a performance threshold in response to the number of one or more simulated requests.

28. The system of claim 27, wherein providing the simulated request includes providing the simulated request to the target system from a client thread.

29. The system of claim 27, wherein each of the scaling factor and the number of one or more simulated requests is determined without human intervention.

30. The system of claim 27, wherein measuring the performance of the target system comprises determining a measured load at the each of the components of the target system responding to the simulated request.

31. The system of claim 27, wherein the performance threshold includes at least one of:
a user-specified load level; or
a performance critical point, wherein a pattern of resource usage before the performance critical point is different from a pattern of resource usage after the performance critical point.

32. A system comprising:
one or more processors configured to perform operations comprising:
providing one or more simulated requests to a target system, the target system including a plurality of components;
identifying a performance bottleneck of the target system, the performance bottleneck including a setting of a component of the target system that caused the target system to exceed a specified load level; and
determining an adjustment factor such that, when a count of the simulated requests is adjusted by the adjustment factor, the target system does not exceed the specified load level, wherein determining the adjustment factor includes iteratively increasing or decreasing the count of the simulated requests and measuring performance of the target system when the target system handles the increased or decreased count of simulated requests.

33. The system of claim 32, wherein the specified load level includes a load indicator defined by at least one of:
a predetermined performance indicator; or
a performance change threshold, wherein an additional simulated request causes a performance indicator of the target system to change an amount that exceeds the performance change threshold, or wherein an additional simulated request causes the performance indicator of the target system to change in a specified pattern.

34. The system of claim 32, wherein identifying the performance bottleneck comprises:
determining that, at the setting of the component, the component is operating at a pre-specified capacity.

35. The system of claim 32, wherein determining the adjustment factor is performed without human intervention.
